(19) United States
(12) Patent Application Publication
(10) Pub. No.: US 2012/0078399 A1
(43) Pub. Date: Mar. 29, 2012

(54) SOUND PROCESSING DEVICE, SOUND FAST-FORWARDING REPRODUCTION METHOD, AND SOUND FAST-FORWARDING REPRODUCTION PROGRAM

(75) Inventors: Junichi KOSAKA, Tokyo (JP); Dezheng Xu, Tokyo (JP); Kosei Yamashita, Kanagawa (JP)

(73) Assignees: SONY CORPORATION, Tokyo (JP); SONY ERICSSON MOBILE COMMUNICATIONS JAPAN, INC., Minato-ku (JP)

(21) Appl. No.: 13/093,045

(22) Filed: Apr. 25, 2011

Related U.S. Application Data
(60) Provisional application No. 61/387,811, filed on Sep. 29, 2010.

(51) Int. Cl. G06F 17/00

(52) U.S. Cl. 700/94

(57) ABSTRACT

An information processing apparatus stores audio data, receives an input instruction of a user, reproduces a first channel of the audio data, which corresponds to normal playback of the audio data, and a second channel of the audio data, which corresponds to a fast-forwarding playback of the audio data based on an instruction received at the input unit, processes the first and second channels of the audio data such that the first and second channels of the audio data are separately audible by the user, and outputs the processed first and second channels of the audio data.

### CROSS REFERENCE TO RELATED APPLICATION

The present application claims the benefit of the earlier filing date of U.S. Provisional Patent Application Ser. No. 61/387,811 filed on Sep. 29, 2010, the entire contents of which is incorporated herein by reference.

### BACKGROUND

1. Field of the Disclosure

The present disclosure relates to a process of reproducing sound data and, more particularly, to a sound processing device for a fast-forwarding operation of sound data being reproduced and a user interface thereof.

2. Description of the Related Art

Recently, mobile telephone terminals, PCs or portable music players having a music reproduction function have become widespread, and music content to be reproduced is also downloaded from a distribution site through a network so as to be easily available.

In addition, small mobile recorders (so-called IC recorder) have also become widespread, and sound is easily recorded in meetings or the like, without being limited to music content.

Such sound data content is compressed and encoded into a predetermined format so as to be held as digital data, and is decoded and converted into an analog signal so as to be acoustically output from a speaker or the like during reproduction.

If a fast-forwarding operation is performed while sound data is reproduced (general reproduction), a plurality of sound data parts distributed beyond the current reproduction position is read and the plurality of sound data parts is sequentially reproduced instead of the general reproduction. If the fast-forwarding operation is finished, the general reproduction is resumed from the sound data part which is currently being reproduced.

In Japanese Unexamined Patent Application Publication Nos. 2008-135891 and 2008-135892, technology for simultaneously reproducing a plurality of pieces of music data and, at this time, performing a predetermined process with respect to the plurality of sound signals such that the music signals are audible by the user through the sense of hearing is disclosed.

### SUMMARY

In the related art, arbitrary sound data may be fast-forwarded using the fast-forwarding operation during reproduction (during listening) such that following content is audibly checked.

In this case, when the original general reproduction is desired to be resumed after the fast-forwarding reproduction is performed by the fast-forwarding operation, it is necessary to take steps that the general reproduction is stopped; and start of the reproduction from the beginning, rewinding from a current position, or the like. To this end, the original general reproduction may not be immediately resumed.

In addition, in the fast-forwarding reproduction by the digital sound reproduction technology in the related art, a reproduction speed for enabling content to be heard to some extent is preferable. However, at such a reproduction speed, if a desired point is distant from the current reproduction position, a corresponding time is used to reach the corresponding point. In contrast, if a reproduction speed is increased, the content may not be recognized.

It is desirable to provide a function of a fast-forwarding operation of new sound data using a technology of separating a plurality of pieces of sound data so as to be simultaneously audible to the sense of hearing.

In addition, the present disclosure provides a sound data selection program executed on a computer or a computer-readable storage medium for storing such a program, in order to realize a step of providing an option of a plurality of pieces of selectively listenable sound data as display information and such a method.

According to the present disclosure, it is possible to reproduce sound of the fast-forwarding reproduction of the same sound data in parallel partway-through the reproduction of sound data, without stopping the reproduction, and to separate and listen to both pieces of sound data. Accordingly, it is possible to immediately return from fast-forwarding reproduction to the original general reproduction.

According to the present disclosure, an information processing apparatus stores audio data, receives an input instruction of a user, reproduces a first channel of the audio data, which corresponds to normal playback of the audio data, and a second channel of the audio data, which corresponds to a fast-forwarding playback of the audio data based on an instruction received at the input unit, processes the first and second channels of the audio data such that the first and second channels of the audio data are separately audible by the user, and outputs the processed first and second channels of the audio data.

### BRIEF DESCRIPTION OF THE DRAWINGS

FIG. 1 is a block diagram showing the overall structure of a sound processing system including a sound processing device according to an embodiment of the present disclosure;

FIG. 2 is a block diagram showing a configuration example of a sound processing unit shown in FIG. 1;

FIG. 3 is a diagram illustrating a frequency band division method of a plurality of sound signals;

FIG. 4 is a diagram illustrating a time division method of a plurality of sound signals;

FIG. 5 is a diagram illustrating a method of showing the position of a virtual sound source;

FIG. 6 is a diagram illustrating a process of differentiating the positions of sound sources of sound data parts reproduced in a multiple manner;

FIG. 7 is a diagram showing a detailed configuration example of changing localization;

FIG. 8 is a diagram illustrating a detailed example of the control of a FIR filter shown in FIG. 7;

FIG. 9 is a diagram illustrating a fast-forwarding operation of the related art shown for comparison with a fast-forwarding operation of the present disclosure;

FIG. 10 is a schematic diagram showing the fast-forwarding operation of an embodiment of the present disclosure;

FIG. 11 is a diagram illustrating a predetermined end operation when general reproduction is desired to be resumed from a current position of fast-forwarding reproduction at the time of the end of the fast-forwarding reproduction operation;

FIGS. 12A to 12D are diagrams showing different configuration examples of a user input unit available in a first embodiment;

FIGS. 13A and 13B are diagrams showing examples of a display screen in a sound reproduction mode using a touch screen;

FIGS. 14A and 14B are diagrams showing the screen shown in FIGS. 13A and 13B in which a bar is additionally displayed;

FIGS. 15A and 15B are diagrams showing examples of a fast-forwarding operation using a touch screen;

FIG. 16 is a diagram showing a relationship between input sound data and a reproduction output in the operations shown in FIGS. 15A and 15B;

FIG. 17 is a diagram showing a relationship between input sound data and a reproduction output when transitioning to a current position of fast-forwarding reproduction when returning to general reproduction;

FIG. 18 is a diagram showing an example of metadata attached to sound data;

FIG. 19 is a flowchart illustrating an example of processing a fast-forwarding operation in a first embodiment of the present disclosure;

FIG. 20 is a flowchart illustrating an example of processing a fast-forwarding operation if the fast-forwarding operation is performed using a touch screen;

FIG. 21 is a diagram showing a relationship between input sound data and a reproduction output in a second embodiment of the present disclosure;

FIG. 22 is a diagram showing a modified example of a second embodiment of the present disclosure;

FIG. 23 is a diagram showing a modified example of a method of changing localization described in FIG. 6;

FIG. 24 is a diagram showing an example of changing an audible direction with time from the start to the end of the reproduction of each song part when four song parts are reproduced in a multiple manner, in the modified example shown in FIG. 23;

FIG. 25 is a diagram showing a plurality of steps of changing the audible direction of the song part with time, in the examples shown in FIGS. 24 and 22; and

FIG. 26 is a flowchart illustrating an example of processing a fast-forwarding operation of a second embodiment of the present disclosure.

### DESCRIPTION OF THE PREFERRED EMBODIMENTS

Hereinafter, the embodiments of the present disclosure will be described in detail with reference to the accompanying drawings.

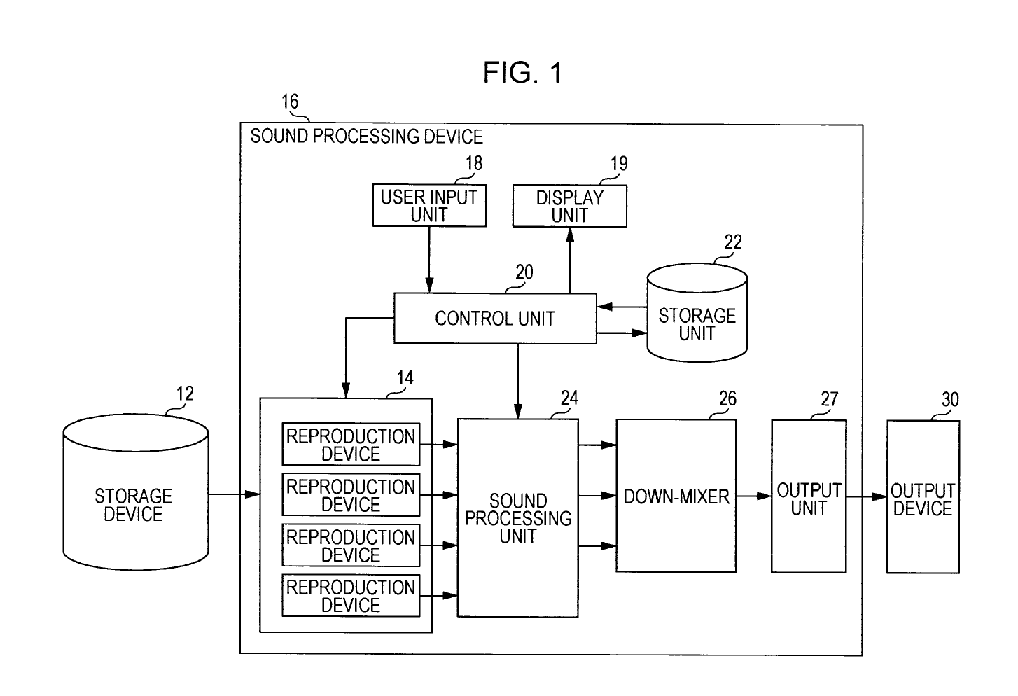

FIG. 1 is a block diagram showing the overall structure of a sound processing system including a sound processing device according to the present embodiment.

This sound processing system provides a user interface for performing various operations for reproducing a plurality of pieces of sound data stored in a storage device or a recording medium. Hereinafter, as one of the operations of this user interface, a fast-forwarding operation performed during sound data reproduction will be described. Hereinafter, two fast-forwarding operations will be largely described as first and second embodiments, respectively.

In the fast-forwarding operation of the first embodiment, general reproduction begins with respect to one piece of sound data among a plurality of pieces of sound data according to a reproduction start operation of a user and then a sound data part at a position beyond the current reproduction position of the same sound data is read and fast-forwarding reproduced in parallel with the general reproduction according to a fast-forwarding operation of the user. In addition, at this time, the generally reproduced sound data and the fast-forwarding reproduced sound data are processed by the below-described sound processing unit such that the generally reproduced sound data and the fast-forwarding reproduced sound data are heard by the sense of hearing so as to be separately audible by the user, and output sound data in which both pieces of sound data are mixed is output.

The fast-forwarding operation of the second embodiment is the same as the first embodiment in that the general reproduction of one piece of sound data among the plurality of pieces of sound data begins according to the reproduction start operation of the user and then the fast-forwarding operation of the user is received, and is different from the first embodiment in that a plurality of sound data parts beyond the current reproduction position of the same sound data is divided into a plurality of sections, and the sections are sequentially read and are reproduced in a multiple manner with a predetermined time difference. At this time, the plurality of sound data parts are processed by the sound processing unit such that the plurality of sound data parts reproduced in the multiple manner are heard by the sense of hearing so as to be separately audible by the user, and output sound data in which the plurality of sound data parts is mixed is output.

In a sound separation process, a plurality of pieces of input sound data is simultaneously reproduced, and a specific filter process is performed such that the plurality of reproduced sound signals is separated and heard. Next, such sound signals are mixed to output sound data having a desired number of channels and are acoustically output from an output device such as a stereo or earphone.

In the present specification, music data is used as an example of sound data. However, the sound data of the present disclosure is not limited to music data and may be applied to data representing any sound such as a spoken word recording, comic storytelling, meetings or the like, environmental sounds, speech sounds or ringtones (melody) of a telephone, a television broadcast or the like, or sound data included in image data recorded on a DVD.

The sound processing system 10 shown in FIG. 1 largely includes a storage device 12 for storing a plurality of pieces of music data, a sound processing device 16 for reading the music data from the storage device 12 and reproducing the music data as a sound signal, and an output device 30 for outputting the sound signal as sound. This configuration is common to the first and second embodiments.

The storage device 12 may include a small storage device mounted in an apparatus, such as a hard disk, and a small-sized storage medium which is detachably mounted in an apparatus, such as a flash memory. The storage device 12 may include a storage device such as a hard disk in a server connected to the sound processing device 16 through a network.

The sound processing device 16 includes a plurality of reproduction devices 14, a user input unit 18, a display unit 19, a control unit 20, a storage unit 22, a sound processing unit 24, a down-mixer 26, and an output unit 27.

The reproduction devices 14 reproduce and output music data (in the present example, a song) selected by the user as a sound signal, and appropriately decode one selected from the music data stored in the storage device 12 so as to generate the sound signal. Although four pieces of music data are simultaneously reproduced and four reproduction devices 14 are shown in FIG. 1, the number of reproduction devices is not limited. The music data simultaneously reproducible by the sound processing device 16 may be different music data, but, in the present embodiment, it is different parts of the same piece of music data. Accordingly, in the present specification, the “sound data” includes a sound data part.

If a reproduction process is performed in parallel by a multi-processor or the like, from the standpoint of appearance, one reproduction device 14 including a plurality of processing units, each of which reproduces each piece of music data and generates the respective sound signal, may be used.

The user input unit 18 is a portion which receives an input operation of a user and, in the present embodiment, has an input area placed on an overlapped display screen of the display unit 19, and includes a touch panel (touch screen) for detecting the position of a user touch. The user input unit 18 used in the present disclosure is not limited to such a configuration and may be an input unit by a hardware key or button. Instead thereof or in addition thereto, for example, at least one input device such as a mouse, a keyboard, a trackball, a joystick or a touch pen may be used.

The display unit 19 displays characters or images on the display screen and includes a display device such as an LCD or an organic EL and a display controller.

The control unit 20 performs the switch of the display of the display unit 19, the conversion of the music data reproduced by the reproduction device 14 and various operations, the control of the operation of the reproduction device 14 or the sound processing unit 24, or the like according to an instruction input from the user input unit 18.

The control unit 20 includes a CPU, various processors, and program memory. The control unit 20 executes the fast-forwarding process which is characteristic in the present embodiment.

The storage unit 22 includes a storage medium such as a memory or a hard disk, for storing music data, information corresponding to each piece of music data, image data, a various types of control data, or the like. The storage unit 22 also stores a table necessary for control by the control unit 20, that is, information such as predetermined parameters.

The sound processing unit 24 performs a predetermined process with respect to a plurality of pieces of input sound data such that the plurality of pieces of input sound data is heard by the sense of hearing so as to be separately audible by the user. The plurality of pieces of input sound data is different parts of the same input sound data in the present embodiment. In more detail, the sound processing unit 24 performs a predetermined filter process with respect to each of the plurality of pieces of input sound data so as to generate a plurality of sound signals (output sound data) heard by the sense of hearing so as to be separately recognized. The details of the operation of the sound processing unit 24 will be described later.

The down-mixer 26 mixes the plurality of sound signals subjected to the predetermined filter process so as to generate an output signal having a desired number of channels.

The output unit 27 includes a D/A converter for converting digital sound data into an analog sound signal, an amplifier for amplifying the output signal, and an output terminal.

The output device 30 includes an electrical acoustic conversion unit for acoustically outputting the mixed sound signal and, in detail, includes a (internal or external) speaker, headphones, and earphones. In the present specification, the term “speaker” is not limited to a speaker and may be any electrical acoustic conversion unit. Although the output device 30 is shown as an external device of the sound processing device 16, it may be mounted in the sound processing device 16.

The sound processing system 10 corresponds to a personal computer, a music reproduction apparatus such as a mobile music player, or an IC recorder. This system may be integrally configured or may be configured by the local connection of a plurality of units.

In addition, the format of the music data stored in the storage device 12 is unimportant. The music data may be encoded by a general encoding format such as MP3.

The down-mixer 26 mixes the plurality of input sound signals after performing various adjustments as necessary and outputs as output signal having a predetermined number of channels, such as monaural, stereo or 5.1 channel. The number of channels may be fixed or may be switched by the user using hardware or software.

In the auxiliary information of the music data stored in the storage unit 22, any general information such as song title, artist name, an icon or a genre of song corresponding to a piece of music data may be included. Further, some of the parameters necessary for the sound processing unit 24 may be included. The information about the music data may be read and stored in the storage unit 22 when the music data is stored in the storage device 12. Alternatively, the information may be read from the storage device 12 and stored in the storage unit 22 whenever the sound processing device 16 is operated.

Now, the sound separation process of allowing one user to separate and listen to a plurality of pieces of music data or music data parts, which is simultaneously reproduced, will be described.

If a plurality of sounds is mixed and heard using a set of speakers or earphones, fundamentally, since separation information is not obtained at the inner ear level, different sounds are recognized by the brain depending on differences in the auditory stream or tone, or the like. However, sounds thus distinguishable are restricted. Accordingly, it is difficult to apply this operation to various sounds.

If the methods proposed by Japanese Unexamined Patent Application Publication Nos. 2008-135891 and 2008-135892 are used, separation information approaching the inner ear or the brain is artificially added to sound signals so as to finally generate sound signals capable of being recognized and separated even when mixed.

That is, if the sound processing unit 24 is configured as follows, it is possible to separate and listen to a plurality of pieces of sound data.

In the sound separation process, a predetermined filter process is performed with respect to each sound signal so as to separate and listen to the music data when the plurality of pieces of music data is simultaneously reproduced, mixed and output. In detail, separation information at the inner ear level is provided by distributing a frequency band or time to the sound signal obtained by reproducing each piece of music data or separation information at the brain level by providing periodic change, performing acoustic processing or providing different localization with respect to some or all of the sound signals. In this way, when the sound signals are mixed, it is possible to acquire the separation information at the inner ear level and the brain level and, finally, to facilitate the separation and recognition of the plurality of pieces sound data. As a result, it is possible to simultaneously observe sounds similar to the viewing of a thumbnail display on a display screen and to readily check a plurality of music contents without spending much time even when wishing to check the contents.

The sound processing unit 24 of the sound processing device 16 of the present embodiment processes each of the plurality of pieces of sound data (sound signals) so as to be heard by the sense of hearing so as to be separately recognized when being mixed.

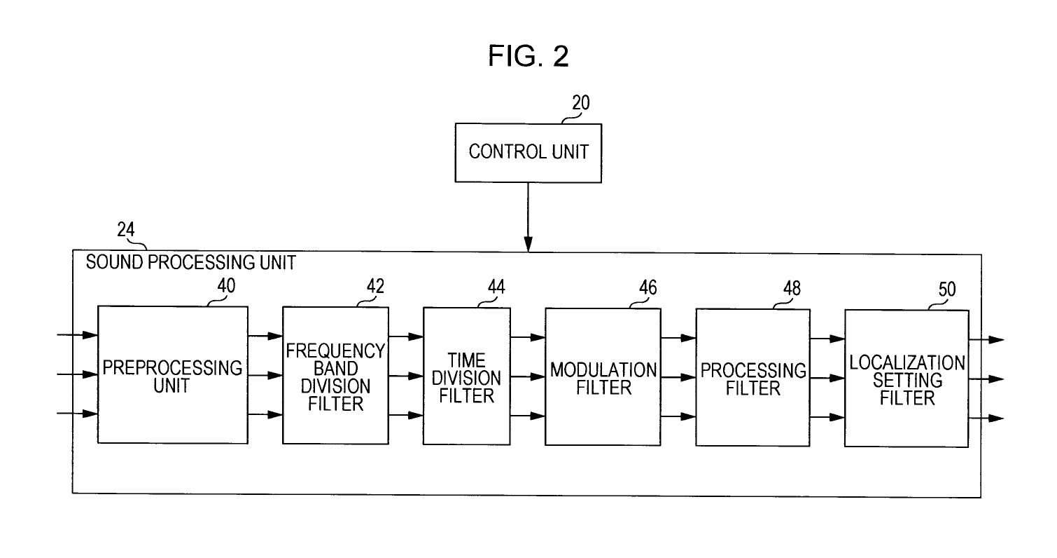

FIG. 2 shows the configuration example of the sound processing unit 24. The sound processing unit 24 includes a preprocessing unit 40, a frequency band division filter 42, a time division filter 44, a modulation filter 46, a processing filter 48, and a localization setting filter 50. All such filters are not indispensable in the present disclosure and at least one kind of the filters may be used. A plurality of filters may be used according to the properties of the filters.

The preprocessing unit 40 may be a general automatic gain controller or the like and controls gain such that the volumes of the plurality of sound signals received from the reproduction device 14 approximately become uniform.

The frequency band division filter 42 allocates a block obtained by dividing the audible band for each sound signal and extracts a frequency component belonging to the block allocated to each sound signal. For example, the frequency band division filter 42 may extract the frequency component by configuring a band pass filter (not shown) provided in every block with respect to each channel of the sound signal. A division pattern for deciding the manner of dividing the block or an allocation pattern for deciding the manner of allocating the block to the sound signal may be changed by enabling the control unit 20 to control each band pass filter or the like so as to set the frequency band or to set the valid band pass filter.

The time division filter 44 performs a time division method of the sound signal and time-modulates the amplitude of each sound signal by changing the phase in a period of several tens of milliseconds to several hundreds of milliseconds. The time division filter 44 is realized by, for example, controlling the gain controller on a time axis.

The modulation filter 46 performs a method of periodically providing a specific change to the sound signal and is realized by, for example, controlling the gain controller, an equalizer, an audio filter, or the like on a time axis.

The processing filter 48 performs a method of normally performing a special effect (hereinafter, referred to as a processing treatment) with respect to the sound signal and is realized by an effector or the like.

The localization setting filter 50 performs a method for changing localization as the position of a virtual sound source and is realized by a three-dimensional localization process or the like of a panpot, a virtual surround or the like.

In the present embodiment, as described above, the plurality of mixed sound signals is heard by the sense of hearing so as to be separately recognized by the user. According to the sound separation process, it is possible to separate and distinguish the plurality of pieces of music data (parts) which is simultaneously output according to the separation listening method, by changing the parameter of each filter provided to the sound processing unit 24. The change pattern of the provided parameter is stored in the storage unit 22 in advance. In addition, such a change pattern may be an internal parameter or a plurality of tables in the sound processing unit 24 in order to perform an optimal process.

As the separation listening method by the sound separation process, in more detail, in the above related art there is a plurality of methods proposed as follows.

(1) Frequency Band Division Method

First, as the method of providing the separation information at the inner ear level, the division of the sound signal in the frequency band and the time division of the sound signal will be described.

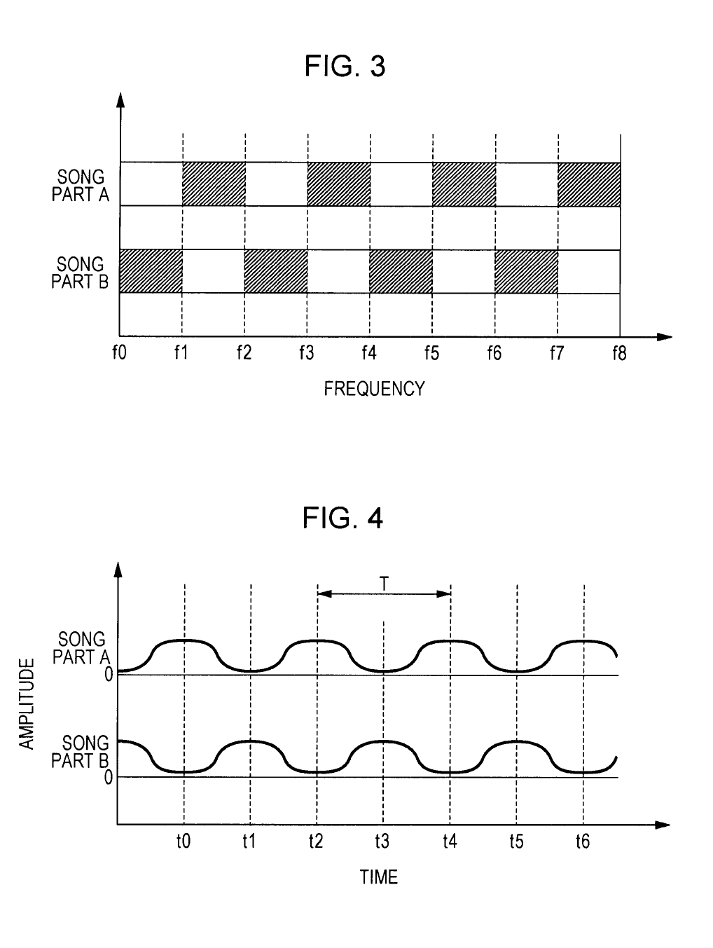

FIG. 3 is a diagram illustrating a frequency band division method of a plurality of sound signals. The horizontal axis of the figure denotes a frequency, and an audible band is in a range from a frequency f0 to a frequency f8. Although the plurality of sound signals may be made up of different songs, in the fast-forwarding reproduction of the present embodiment, different song parts of the same song are processed. Accordingly, in the same figure, the case where the sound signals of two song parts A and B are mixed is shown. The number of song parts is not specially limited. In the frequency band division method, the audible band is divided into a plurality of blocks and each block is allocated at least one of the plurality of sound signals. Thereafter, only the frequency component belonging to the block allocated to each of the plurality of sound signals is extracted from the plurality of sound signals.

In the example shown in FIG. 3, the audible band f0 to f8 is divided into eight blocks by dividing the entire frequency range by frequencies f1, f2, . . . , and f7. For example, as denoted by diagonal lines, four blocks f1 to f2, f3 to f4, f5 to f6 and f7 to f8 are allocated to the song part A and four blocks f0 to f1, f2 to f3, f4 to f5 and f6 to f7 are allocated to the song part B. Here, the frequencies f1, f2, . . . , and f7 which become the boundaries between the blocks are set to, for example, any one of the boundary frequencies of 24 Bark threshold bands such that the effect of the frequency band division is further increased.

The threshold band refers to a frequency band in which, even when sound having a certain frequency band extends to a larger bandwidth, increase of a masking amount of the other sound is not increased. Masking is a phenomenon in which the minimum audible value of any sound is increased by the presence of the other sound, that is, a phenomenon in which it is difficult to listen to either sound. The masking amount is the amount of increase of the minimum audible value. It is difficult for sounds in different threshold bands to mask each other. By dividing the frequency band using the 24 Bark threshold bands approved by experiments, it is possible to suppress influence in which, for example, the frequency component of the song part A belonging to the block of the frequencies f1 to f2 masks the frequency component of the song part B belonging to the block of the frequencies f2 to f3. The same is true in the other blocks and, as a result, the song part A and the song part B become the sound signals which hardly interfere each other.

In addition, division of the entire frequency region into the plurality of blocks may not be performed using the threshold bands. In either case, it is possible to provide the separation information using the frequency resolution of the inner ear, by reducing the overlapping frequency bands.

Although, in the example shown in FIG. 3, each block has substantially the same bandwidth, in practice, the bandwidth may be changed by the frequency band. For example, two threshold bands may be set to one block and four threshold bands may be set to one block. In the division method (division pattern) division into the blocks may be determined in consideration of the characteristics of ordinary sound, for example, characteristics in which it is difficult to mask sound having a low frequency, or in consideration of a characteristic frequency band of a song part. Here, the characteristic frequency band is, for example, an important frequency band in the depiction of the song such as a frequency band occupied by a melody.

In addition, although, in the example shown in FIG. 3, a series of blocks is alternately allocated to the song part A and the song part B, the allocation method is not limited to the shown method and two continuous blocks may be allocated to the song part A. Even in this case, for example, when the characteristic frequency band of any song part crosses two continuous blocks, the two blocks may be allocated to that song part; that is, the allocation method may be determined such that the generation of the adverse influence of the frequency band division is suppressed and minimized in the important portion of the song part.

(2) Time Division Method

FIG. 4 is a diagram illustrating a time division method of a plurality of sound signals. In the same figure, a horizontal axis denotes a time and a vertical axis denotes the amplitude, that is, the volume, of the sound signal. Even in this case, the case where the sound signals of two song parts A and B are mixed and heard is shown. In the time division method, the amplitude of the sound signal is modulated in the common period. At this time, the phase of the peak is delayed such that the peak appears at different timings according to a song part. To approach the inner ear level, the modulation period at this time may be a several tens of milliseconds to a several hundreds of milliseconds.

In the example of FIG. 4, the amplitudes of the song part A and the song part B are modulated in the common period T. The amplitude of the song part B is decreased in time points t0, t2, t4 and t6 when the amplitude of the song part A reaches its peak and the amplitude of the song part A is decreased in time points t1, t3 and t5 when the amplitude of the song part B reaches its peak. In addition, in practice, as shown in the same figure, the amplitude modulation may be performed such that the time point when the amplitude is maximized and the time point when the amplitude is minimized has a certain level of time width. In this case, the time when the amplitude of the song part A is minimized may match the time when the amplitude of the song part B is maximized. If three or more song parts are mixed, the phase of the peak of each song part is equally delayed such that only the amplitude of one specific song part may be maximized at a given time.

On the other hand, modulation of a sine wave which does not have a time width at the time point when the amplitude reaches its peak may be performed. In this case, only the phase is delayed and the timing when the amplitude reaches its peak becomes different. In either case, it is possible to provide the separation information using the time resolution of the inner ear.

(3) Method of Providing Separation Information at Brain Level

Next, a method of providing separation information at the brain level will be described. The separation information provided at the brain level provides clues to recognizing the auditory stream of each sound when the brain analyzes sound. In the present embodiment, a method of periodically providing a specific change to sound signals, a method of normally performing a processing treatment with respect to sound signals, and a method for changing localization are introduced.

(3-1) In the method of periodically providing the specific change to the sound signals, the amplitudes of all or a part of mixed sound signals are modulated or the frequency characteristics are modulated. The modulation may be performed in a pulse shape for a short period of time or may be performed so as to slowly vary for a long period time. If the common modulation is performed with respect to the plurality of sound signals, the timings of the peaks of the sound signals are different.

Alternatively, noise such as flick sound may be periodically provided, a processing treatment realized by a general sound filter may be performed, or localization may be swung to the left or the right. By combining such modulations, applying another modulation by the sound signals, or delaying timings, it is possible to provide clues to recognizing the auditory stream of the sound signals.

(3-2) In the method of normally performing the processing treatment with respect to the sound signals, one or a combination of various acoustic processes such as echo, reverb, pitch shift, which are able to be realized using a general effector, is performed with respect to all or a part of mixed sound signals. Normally, the frequency characteristics may be different from those of the original sound signals. For example, even in different song parts of the same song, one song part is subjected to echo processing and thus is prone to be recognized as a different song part. If the processing treatment is performed with respect to a plurality of sound signals, processing content or processing strength becomes different according to the sound signals.

(3-3) In the method of changing the localization, different localizations are provided to all of the mixed sound signals. By performing acoustic spatial information analysis in the brain in cooperation with the inner ear, it is easy to separate the sound signals. Since the sound separation process using the change of the localization is changed so as to separate the positions of virtual sound sources, it may be a sound source separation process.

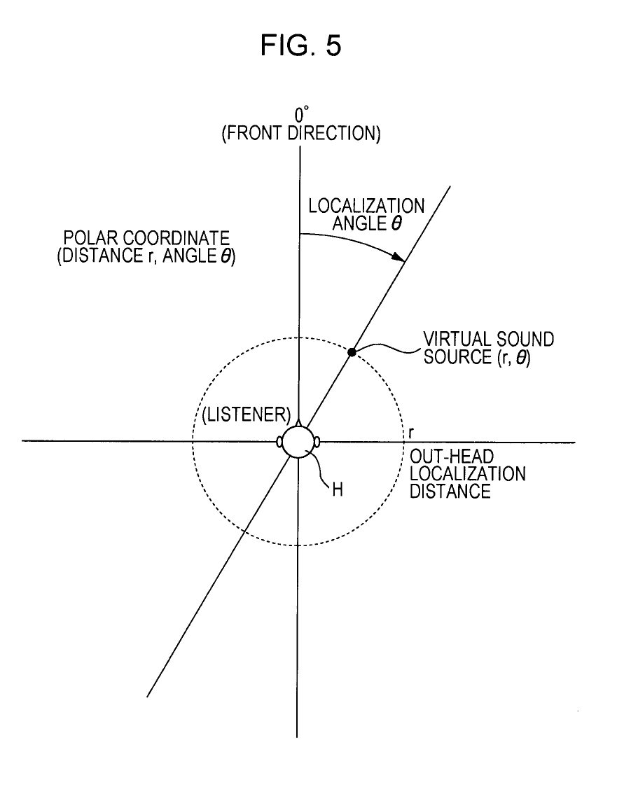

As shown in FIG. 5, the position of the virtual sound source is represented by a song coordinate (that is, an out-head localization distance r and a localization angle θ) in the horizontal plane centered on the head portion H of a listener (user). In this example, in the localization angle θ, the direction to front of the user is 0°.

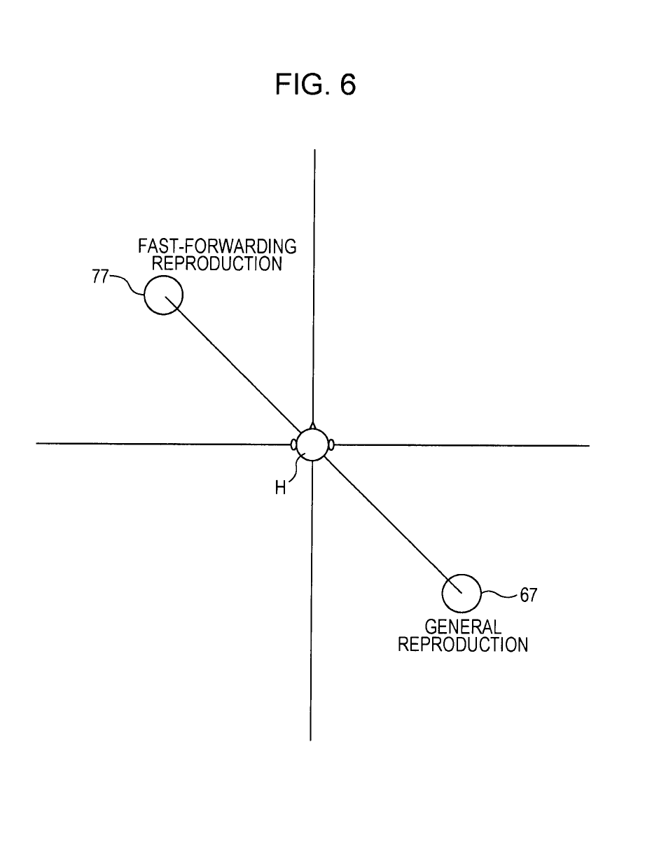

As shown in FIG. 6, the sound processing unit may process a plurality of song parts by differentiating the positions of the sound sources of the generally reproduced song part and the fast-forwarding reproduced song part, both of which are reproduced in parallel, such that the plurality of song parts are audible from different directions. That is, in a horizontal plane centered on the head portion H of the user, different directions of the whole circumference of 360° on the horizontal plane are allocated to the generally reproduced song part and the fast-forwarding reproduced song part. Typically, the localizations are changed so as to allocate virtual sound sources to two song parts in directions differing by 180°. In the figure, a position 67 to the right back side of the user is allocated to the generally reproduced song part and a position 77 to the left front side of the user is allocated to the fast-forwarding reproduced song part. Although the positions 67 and 77 are located at the same distance from the user, they are not necessarily the same distance. Even when the song is in stereo sound having a plurality of channels and includes a plurality of virtual sound source positions, in this example, the virtual sound source position of the song part A is aggregated to a single virtual sound source position 67 while the plurality of song parts is simultaneously reproduced. Even in the song part B, the virtual sound source position is aggregated to a single virtual sound source position 77.

Although the localization angles of the general reproduction and the fast-forwarding reproduction of the two song parts shown in FIG. 6 are different by 180°, the difference may not be 180°. For example, an angular interval may be 60° or 90° at a left front side and a right front side. In addition, the direction of the virtual sound source is not limited to the example of FIG. 6. If the number of song parts reproduced simultaneously is 3 or more, it is possible to allocate different directions obtained by dividing the whole 360° circumference by the number of respective song parts.

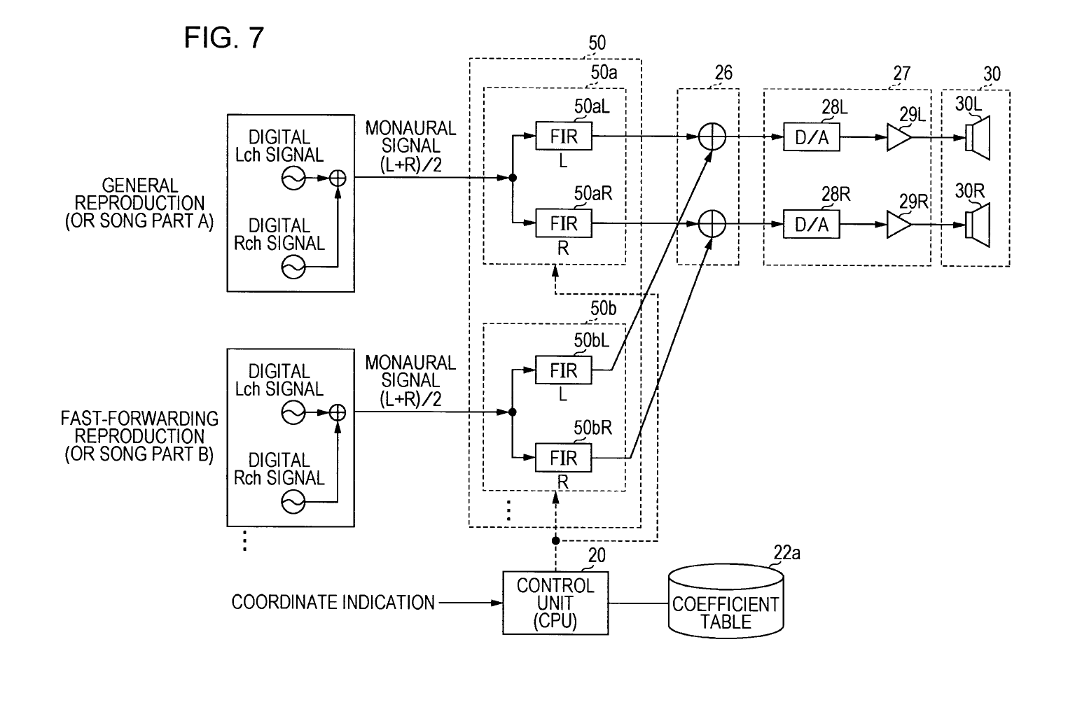

FIG. 7 is a diagram showing a detailed configuration example of changing localization. In this figure, the same elements as the elements shown in FIG. 1 are denoted by the same reference numbers and the description thereof will be omitted.

Now, it is assumed that the generally reproduced song part and the fast-forwarding reproduced song part are reproduced in parallel. If the sound signal of the generally reproduced song part obtained from the reproduction device 14 of one unit includes a digital L channel signal and a digital R channel signal, a monaural signal (L+R)/2 obtained by synthesizing both signals is input to a filter unit 50a. The filter unit 50a is formed of Finite Impulse Responses (FIRs) of the two L and R channels as a portion of a localization setting filter 50. If the sound signal of the song part A is originally a monaural signal, the monaural signal may be input to the filter unit 50a without change.

Similarly, if the sound signal of the fast-forwarding reproduced song part obtained from the reproduction device 14 of another unit includes a digital L channel signal and a digital R channel signal, a monaural signal (L+R)/2 obtained by synthesizing both signals is input to another filter unit 50b. The filter unit 50b is formed of FIRs of the two L and R channels as a portion of the localization setting filter 50.

The filter units 50a and 50b receive control parameters from the control unit 20 and generate L and R channel output sound data for realizing predetermined localization. The control parameters are stored in the storage unit 22 in advance as a coefficient table 23. In this example, in the coefficient table 23, parameters of a Head Related Transfer Function (HRTF) are stored. The HRTF is a function indicating the transfer characteristics of sound transferred from a sound source to human ears. This function has a value changed by the shape of the head or the ears and the position of the sound source. In contrast, by using this function value, it is possible to virtually change the position of the sound source.

In the above-described example of FIG. 6, the filter unit 50a is controlled such that the generally reproduced song part is heard from the virtual sound source position 67 by the control of the control unit 20. Similarly, the filter unit 50b is controlled such that the fast-forwarding reproduced song part is heard from the virtual sound source position 77 by the control of the control unit 20.

The L channel output signals of the filter units 50a and 50b are superposed in a down-mixer 26, are converted into an analog signal by a D/A converter 28L of an output unit 27, are amplified by an amplifier 29L, and are output as sound from an L channel speaker 30L of an output device 30. Similarly, the R channel output signals of the filter units 50a and 50b are superposed in the down-mixer 26, are converted into an analog signal by a D/A converter 28R of the output unit 27, are amplified by an amplifier 29R, and are output as sound from an R channel speaker 30R of the output device 30.

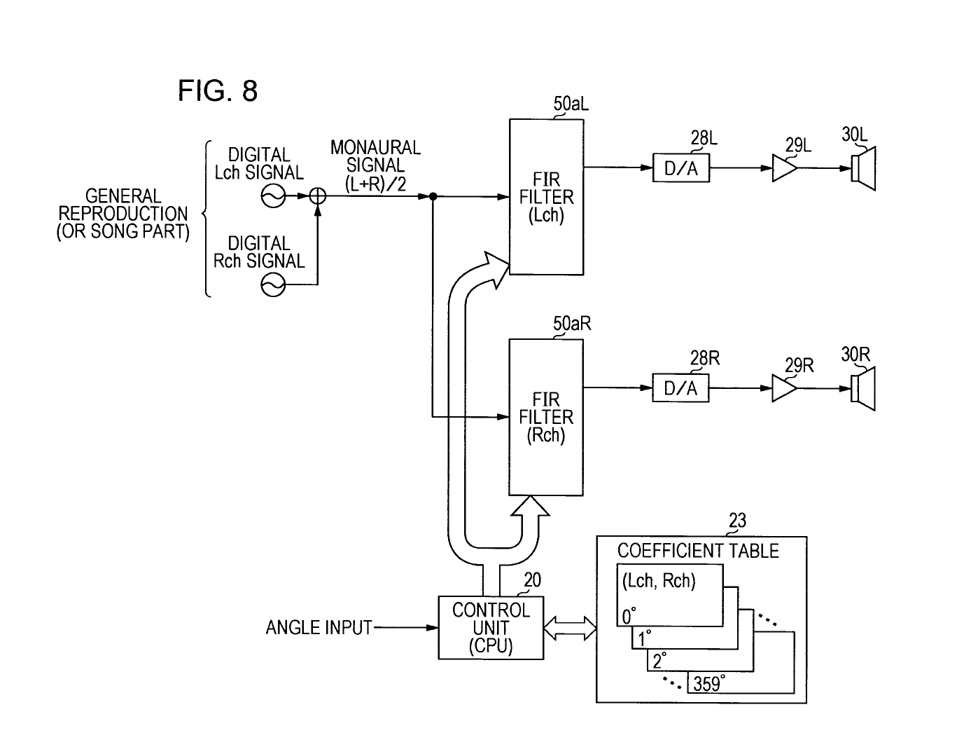

FIG. 8 is a diagram illustrating a detailed example of controlling FIR filters 50aL and 50aR by the control unit 20. In the figure, for convenience, only the generally reproduced song part is shown. In addition, in the coefficient table 23, table values to be provided to the L channel FIR filter and the R channel FIR filter of every different direction (way) of the virtual sound source are prepared. Although the example of the table values having an angular interval of 1° is shown in this example, the angular interval is not limited to 1°. The distance r from the user to the virtual sound source is set to a predetermined value. If the distance r is changed, a coefficient table 23 of each different distance may be provided.

Hereinafter, a detailed example of a user interface of a fast-forwarding operation using the separation listening method as described above in the first embodiment will be described.

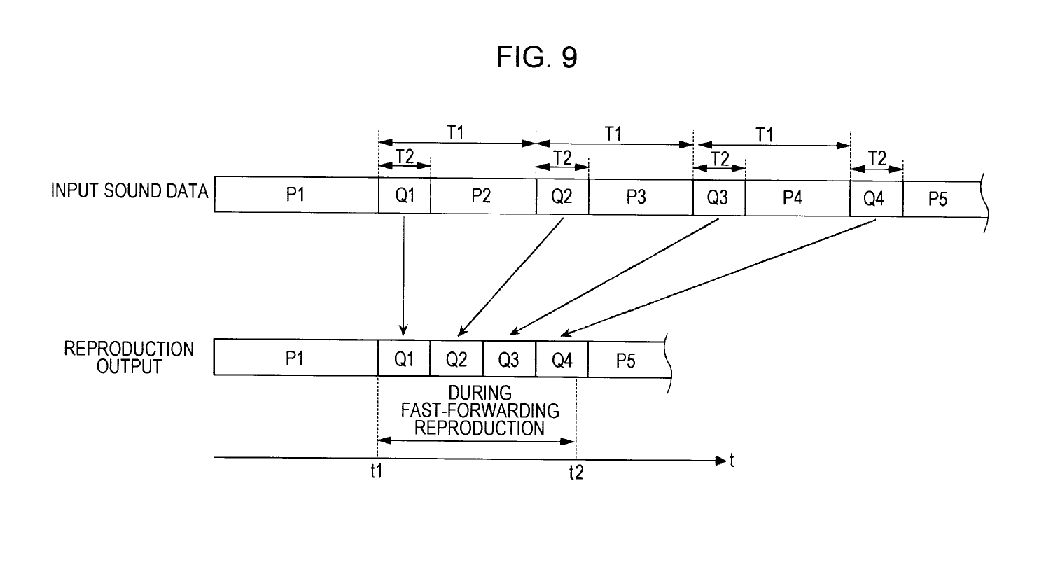

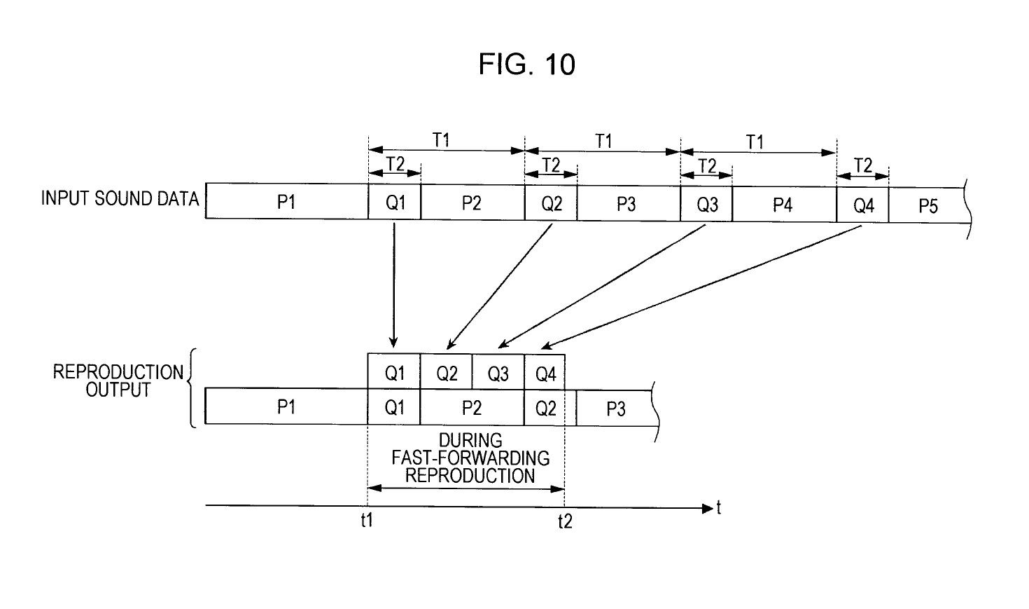

FIG. 9 is a diagram illustrating a fast-forwarding operation of the related art shown for comparison with a fast-forwarding operation of the present disclosure. FIG. 10 is a schematic diagram showing the fast-forwarding operation of the present embodiment.

As shown in FIG. 9, in the fast-forwarding operation of the related art, at a time point t1 when the fast-forwarding operation is started by the user during the reproduction of the input sound data, non-reproduced parts of a plurality of positions beyond (located at the future position of) the current reproduction position of the input sound data are read out and, instead of the general reproduction, the sound data parts of the plurality of positions are sequentially reproduced and output. In this example, the non-reproduced parts of the plurality of positions are sound data parts Q1, Q2, Q3, . . . of a plurality of positions of a constant duration T2 (<T1) distributed in every period T1. In the figure, the sound data part denoted by “Q” indicates a part to be reproduced during the fast-forwarding operation and the sound data part denoted by “P” indicates a part to be excluded from the reproduction target during the fast-forwarding operation. At a time point t2 when the fast-forwarding operation is finished (partway Q4), the general reproduction is resumed with respect to a subsequent sound data part P5 from the reproduction position of that time point. In addition, the sound data part Q2 just after the time point t1 may not be used as a fast-forwarding reproduction target.

In contrast, as shown in FIG. 10, in the present embodiment, at a time point t1 when the fast-forwarding operation is started, as a reproduction output, in a state in which the general reproduction continues, the fast-forwarding reproduction is simultaneously performed in parallel. At this time, the sound separation process performed between the general reproduction and the fast-forwarding reproduction was described above. Accordingly, the user may listen to the fast-forwarding reproduced sound while continuously listening to the generally reproduced sound. At a time point t2 when the fast-forwarding reproduction operation is finished, the fast-forwarding reproduction is stopped and the general reproduction which has continued even during the fast-forwarding reproduction independently continues without change. Accordingly, in view of the user, an additional operation for returning the reproduction position to the position of the original general reproduction is unnecessary.

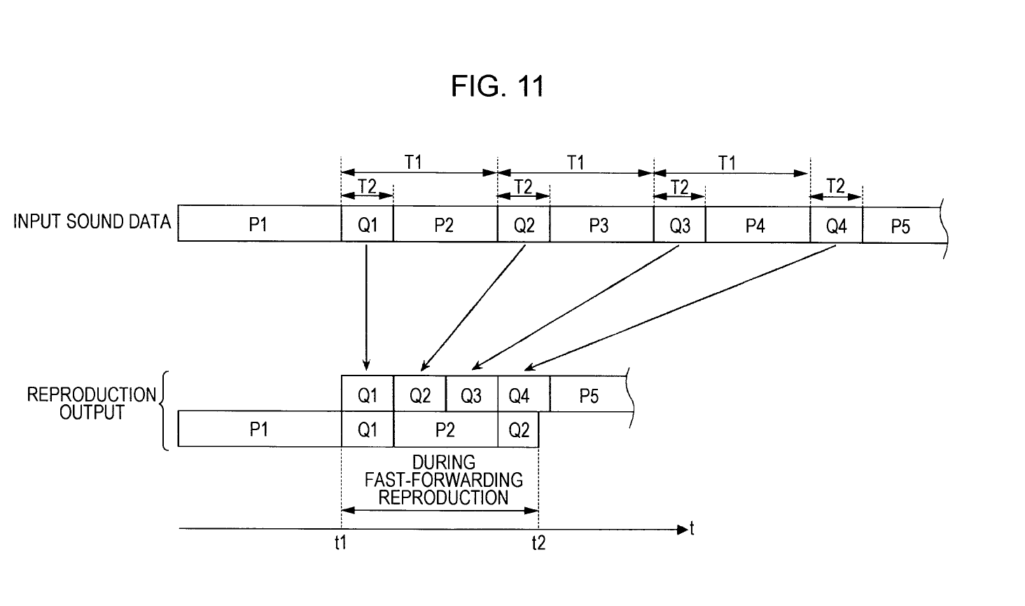

As shown in FIG. 11, at the time of the end of the fast-forwarding reproduction operation, similar to the related art, if the general reproduction is desired to be resumed from the current position of the fast-forwarding reproduction, the below-described predetermined end operation is performed. That is, when the predetermined end operation is performed, general reproduction is resumed from the reproduction position of the current fast-forwarding reproduction.

In FIGS. 10 and 11, the end operation or instruction of the fast-forwarding operation by the user may be different.

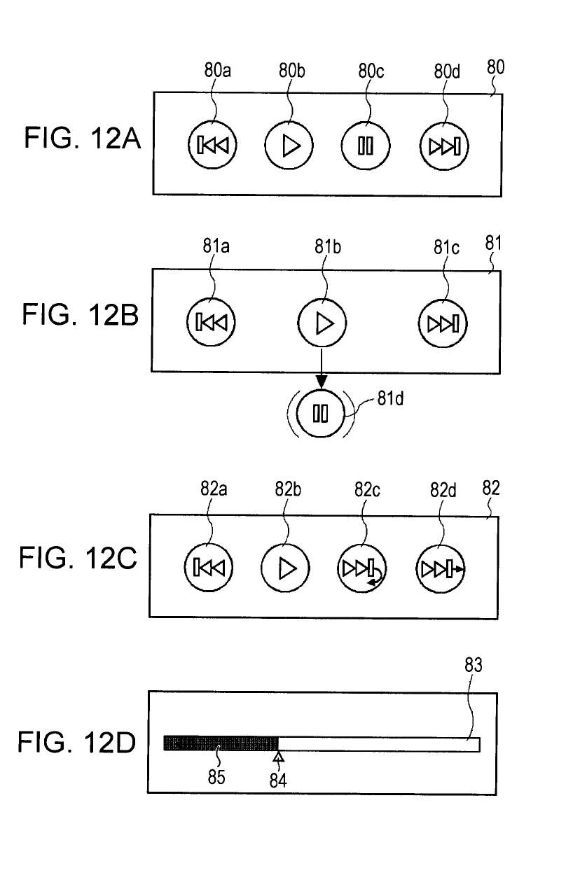

FIGS. 12A to 12D are diagrams showing different configuration examples of a user input unit 18 available in a first embodiment.

The input unit 80 shown in FIG. 12A has buttons (or keys) 80a, 80b, 80c and 80d for input of instructions for the respective operations such as rewinding, play, pause (stop), and fast-forwarding. This input unit 80 may be also realized by hardware keys or software keys. While the fast forward button 80d is pressed, the fast-forwarding operation continues and, when the pressing of the same button is stopped, the fast-forwarding operation is finished. At the time the fast-forwarding operation ends, the original general reproduction continues or the fast-forwarding reproduction is switched to new general reproduction depending on whether or not the fast-forwarding button 80d is pressed simultaneously with another button.

The input unit 81 shown in FIG. 12B has buttons (or keys) 81a, 81b and 81c for instructing the respective operations such as rewinding, play and fast-forwarding. This input unit 81 is realized by software keys and each button is provided as a display image. The play button 81b is alternately switched with the pause button according to each instruction of the user. While the fast forward button 81c is pressed, the fast-forwarding operation continues and, when pressing of the same button is stopped, the fast-forwarding operation is finished. At the time the fast-forwarding operation ends, the original general reproduction continues or the fast-forwarding reproduction is switched to a new general reproduction by the above method. If the input unit 81 is formed of a touch panel (touch screen) having a display function, the switching may be performed by the presence/absence of a flick operation when a finger is separated from the fast-forwarding button 81c. The flick operation refers to, for example, an operation of rapidly moving a finger in a state in which a finger touches the touch panel. That is, in such an operation, the finger is moved at a speed higher than a predetermined speed in a touch state so as to release the touch state.

The input unit 82 shown in FIG. 12C has two types of fast forward buttons 82c and 82d in addition to buttons (or keys) 82a and 82b for instructing the respective operations of rewinding and play. The fast forward buttons 82c and 82d are to distinguish whether the original general reproduction continues or fast-forwarding reproduction is switched to a new general reproduction at the time of the end of the fast-forwarding operation, respectively. For example, the fast forward button 82c is used to enable the original general reproduction to continue at the time of the end of the fast-forwarding operation. The fast forward button 82d is used to set the reproduction position of the fast-forwarding reproduction to the resumed position of the new general reproduction at the time of the end of the fast-forwarding operation. This input unit 82 is also realized by hardware keys or software keys.

The present disclosure is not limited to the shown examples and, in the software keys, only necessary keys may be displayed.

The input unit 83 shown in FIG. 12D shows an example of executing a fast-forwarding operation by a touch screen. A band-shaped bar 83 representing the reproduction progress state of the sound data which is being reproduced is displayed on the touch screen during the general reproduction of the song. In this example, this bar 83 extends in a horizontal direction on the screen and the left end and the right end thereof correspond to a start point to an end point of one piece of sound data to be reproduced. The current reproduction position on the bar 83 is represented by a mark (or a pointer) 84. The mark 84 is moved from the left end to the right end of the bar 83 according to the progress of the reproduction of the song. The reproduced song part is identified and displayed by a bar part 85 of which the color, the luminance or the like is changed. During the general reproduction, according to a predetermined fast-forwarding operation (in this example, a long press touch operation) of the user for the position beyond the current reproduction position on the bar 83, in parallel with the general reproduction, the song part at the position beyond the current reproduction position of the same song is read and reproduced. Such reproduction is also called “fast-forwarding” reproduction in the present specification. The fast-forwarding operation using such a touch screen will be described later in detail.

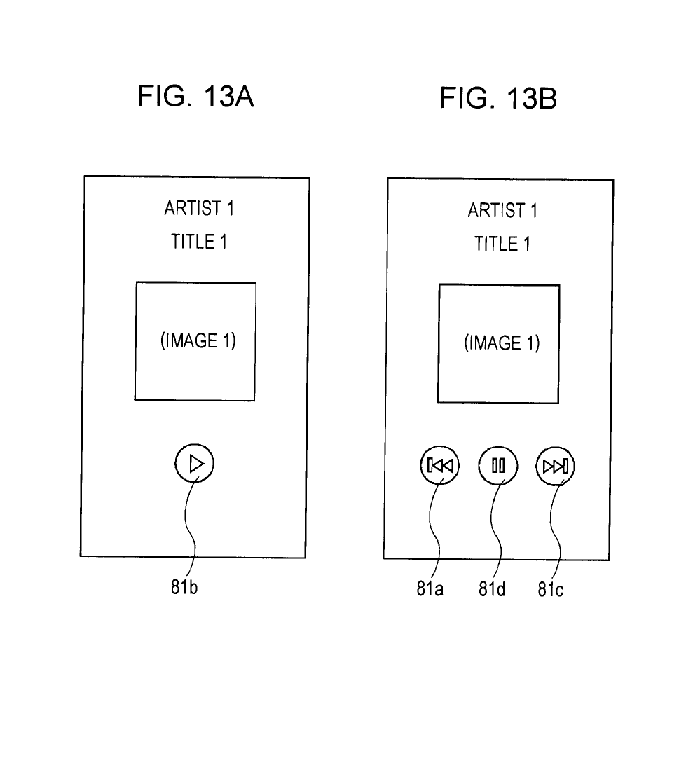

FIGS. 13A and 13B are diagrams showing examples of a display screen in a sound reproduction mode using a touch screen. FIG. 13A shows a screen immediately before arbitrary sound data is selected and reproduced. In this screen, the input unit corresponding to the input unit 81 shown in FIG. 12B is displayed below text information (artist name and title) and an image. In FIG. 13A, only the play button 81b is shown. In the screen after the reproduction is started as shown in FIG. 13B, the play button 81b is switched to the pause button 81d and the rewind button 81a and the fast forward button 81c are additionally displayed.

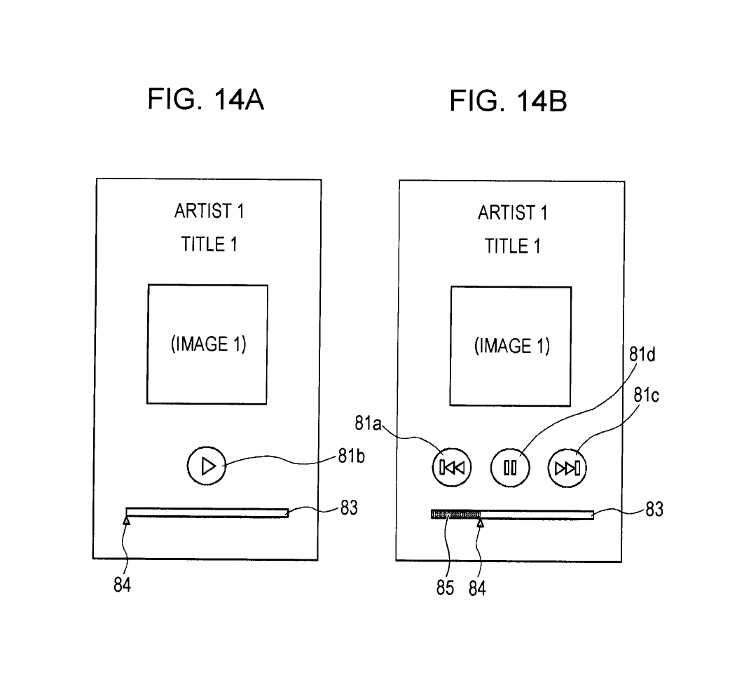

FIGS. 14A and 14B are diagrams showing the screen shown in FIGS. 13A and 13B in which the above-described bar 83 is additionally displayed. FIG. 14A shows a screen immediately before arbitrary sound data is selected and reproduced. At this time, the mark 84 is stopped at the left end position on the bar 83. FIG. 14B shows a screen after the reproduction is started. The current reproduction position is represented by the mark 84 on the bar 83. The entire length of the bar 83 corresponds to the entire length of the input sound data which is being reproduced. Accordingly, the fast-forwarding reproduction start point of the input sound data may be determined according to the touch position on the bar 83.

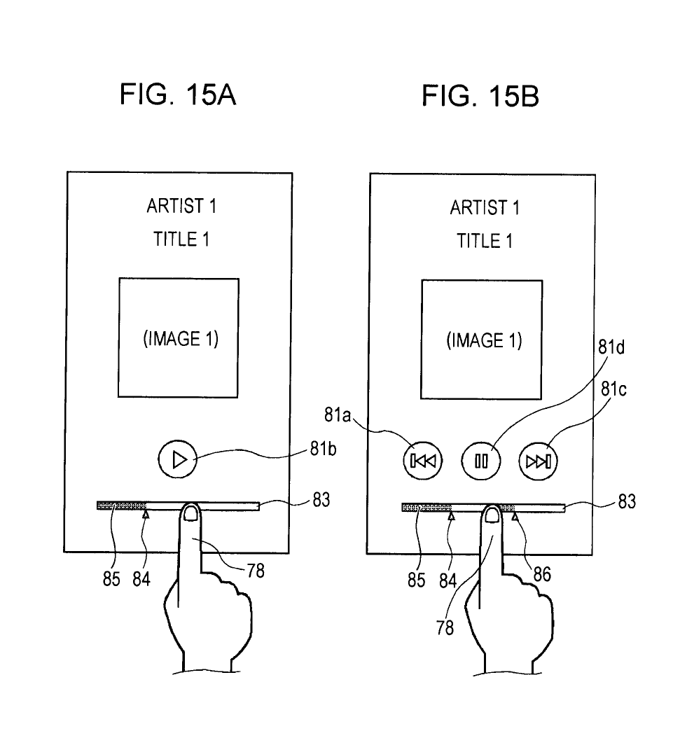

In the state of FIG. 14B, as shown in FIG. 15A, if the user performs a predetermined fast-forwarding operation (in this case, a long press touch operation) of the user for the position (in the figure, the right side) beyond the current reproduction position (the position of the mark 84) on the bar 83 with the finger 78, in parallel with the general reproduction, the sound data part corresponding to that position of the same sound data is read and fast-forwarding reproduced. At this time, in a state in which the sound separation process is performed with respect to the generally reproduced sound data and the fast-forwarding reproduced sound data by the sound processing unit, output sound data in which both pieces of sound data are mixed is output.

The screen of FIG. 15B shows a state in which a time has elapsed after the long press touch operation is performed. That is, within that time, the song part undergoing fast-forward reproduction from the touch position is displayed as a bar part 87 which is identified and displayed. From this figure, it can be seen that, in parallel with the extension of this bar part 87, the bar part 85 of the general reproduction extends by the same time. In the state of FIG. 15B, if the user separates the finger 78 from the screen, the fast-forwarding reproduction finishes, the display of the bar part 87 and the mark 86 disappear and only the general reproduction of the bar part 85 is continuously executed.

In the user interface shown in FIG. 15B, the fast-forwarding reproduction by the bar 83 and the fast-forwarding reproduction by the fast-forwarding button 81c are performed in parallel. In this case, the fast-forwarding reproduction by the fast-forwarding button 81c may be the same as that of the related art or the fast-forwarding reproduction of the above-described first embodiment or the below-described second embodiment.

The execution process may be switched by the long press touch operation and a simple touch operation (that is, a tap operation) shown in FIG. 15A. For example, in the tap operation, a change (jump) of the general reproduction position may be performed.

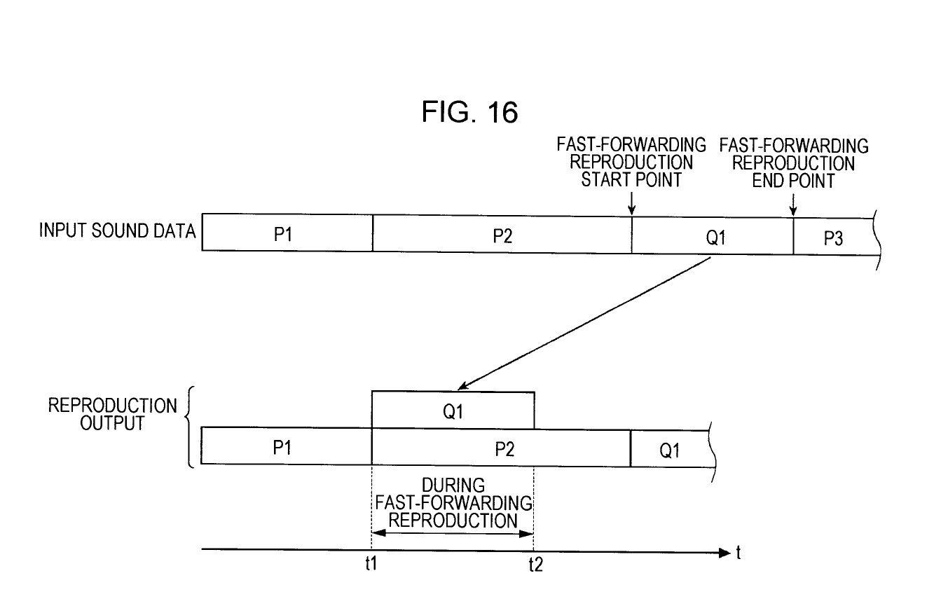

In FIG. 16, the relationship between the input sound data and the reproduction output in the operation shown in FIGS. 15A and 15B is shown. During the reproduction of the input sound data, the long press touch operation for the bar 83 is performed at the time point t1. The touch point on the bar 83 at this time point is recognized as the fast-forwarding reproduction start point (the leading part of the data part Q1) of the input sound data. The fast-forwarding operation is finished at the time point t2 when the long press touch operation is finished. The fast-forwarding reproduction end point of the input sound data corresponds to the current position of the fast-forwarding reproduction at a time point when the long press operation is finished.

In the state of FIG. 15B, when the long press touch operation is finished and a predetermined end operation is performed, the general reproduction may be resumed from the reproduction position of the fast-forwarding reproduction. As the predetermined end operation, for example, a flick operation for the touch screen may be employed.

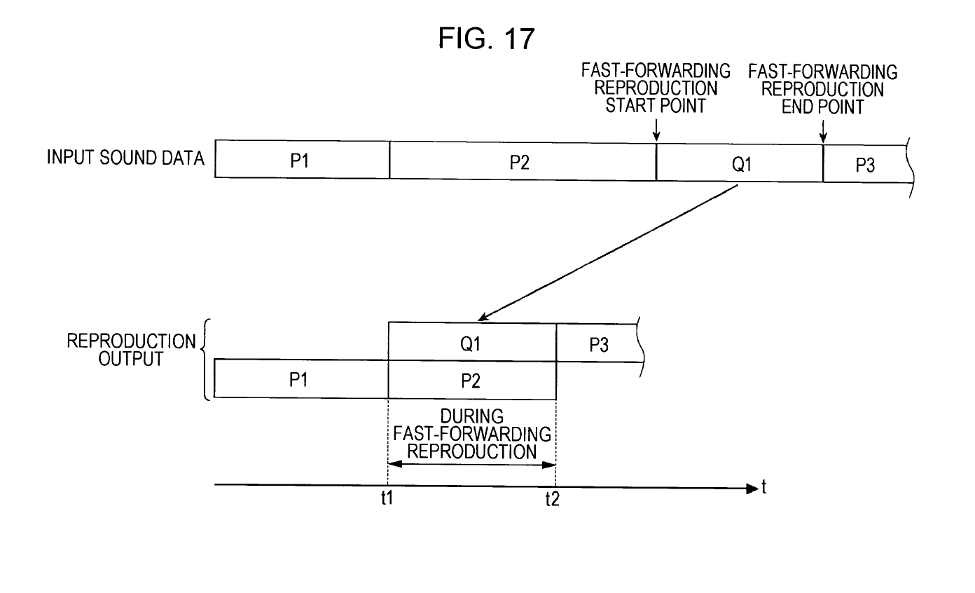

In FIG. 17, a relationship between input sound data and a reproduction output when transitioning to the current position of the fast-forwarding reproduction when returning to general reproduction is shown. As can be seen from the comparison with FIG. 16, the general reproduction up to that time is finished at the end time point t2 of the fast-forwarding operation, and the general reproduction is resumed with respect to the input sound data part P3 subsequent to the input sound data part Q1 which has been fast-forwarding reproduced.

In addition, the transition to the current position of the fast-forwarding reproduction when returning to the general reproduction may correspond to the end of the long press operation using a flick operation or the end of the simple long press operation. That is, if the flick operation is performed when returning to the general reproduction, the transition to the current position of the fast-forwarding reproduction may be performed, and vice versa. This correspondence is initially set and may be arbitrarily selected by the user.

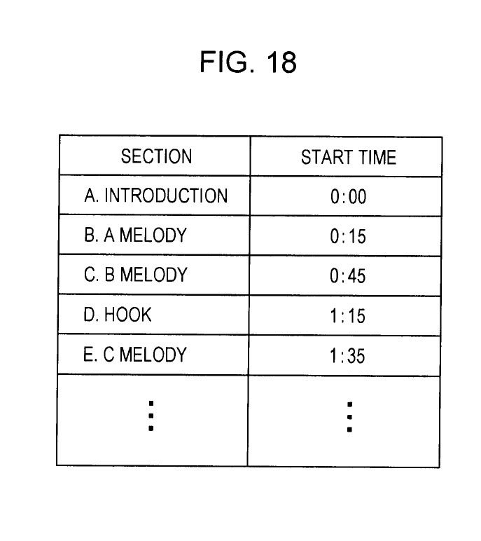

In the above first embodiment, fast-forwarding reproduced targets were sound data parts (Q1, Q2, Q3, . . . ) of the durations T2 of the plurality of positions within the period distributed in the every period T1 beyond the current reproduction position of the input sound data. Instead of the period T1, the other information may be used. For example, according to the sound data, a plurality of parts may be partitioned in advance by metadata attached thereto. For example, in music content such as pop songs, metadata shown in FIG. 18 may be attached to sound data so as to be divided into a plurality of parts such as an introduction part, an A melody part, a B melody part, a hook part, and a C melody part. In classic music, one song may be divided into a plurality of parts called movements. If one song is divided into a plurality of parts in advance, such parts may be used instead of the period T1. In this case, compared with the period T1, the duration T2 may be changed (for example, may be lengthened).

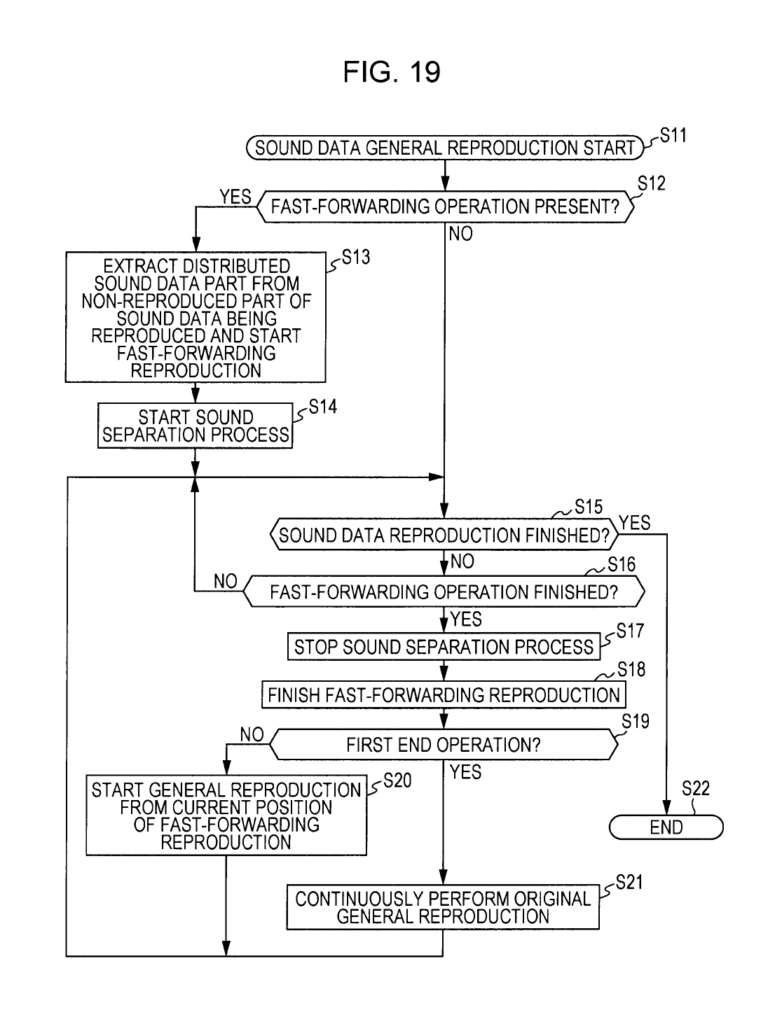

FIG. 19 is a flowchart illustrating an example of processing a fast-forwarding operation in the first embodiment. This process is realized by enabling the control unit 20 shown in FIG. 1 to read and execute a control program (computer program) stored in the storage device (in the control unit or the storage unit 22). The same is true in the below-described flowchart.

This process is executed from the start of the general reproduction of the sound data (S11).

During the general reproduction of the sound data, whether or not the fast-forwarding operation is performed by the user input unit 18 (S12) is monitored. If the fast-forwarding operation is detected, as described above, the distributed sound data parts are extracted from the non-reproduced parts of the sound data which is being reproduced and the fast-forwarding reproduction is additionally started in parallel with the general reproduction (S13). The sound separation process is simultaneously started with respect to the general reproduction and the fast-forwarding reproduction (S14). Thereafter, the process progresses to step S15.

If the general reproduction of the sound data is finished (S15), the present process is finished (S22). When the fast-forwarding operation is finished (S16), the sound separation process is stopped (S17) and the fast-forwarding reproduction is finished (S18). The case where the fast-forwarding reproduction is finished earlier than the general reproduction to the same as a case where the fast-forwarding operation is finished.

Depending on whether or not the operation for instructing the end of the fast-forwarding operation of step S16 is a first end operation, the process branches into step S20 or S21. If it is not the first end operation, it is determined that it is a second end operation. One of the first and second end operations is the operation for simply finishing the above-described fast-forwarding operation and the other is a specific operation such as the flick operation. In the parallel usage of the above-described fast forward button and another button, the presence or absence of the parallel usage corresponds to the first and second end operation. Even when the above-described plurality of fast forward buttons is used, any one of the first and second end operations is determined depending on which fast forward button is used.

In step S21, the original general reproduction continues. In step S22, the general reproduction is resumed from the current position (or a predetermined position) of the fast-forwarding reproduction.

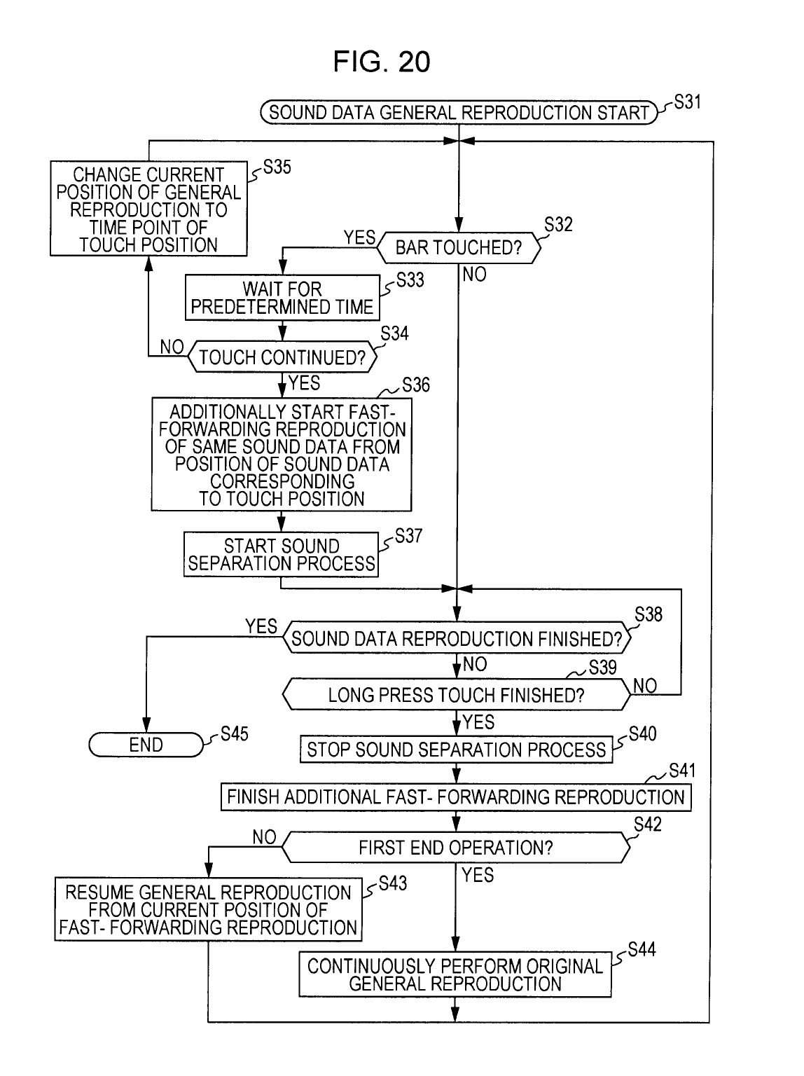

FIG. 20 is a flowchart illustrating an example of processing the fast-forwarding operation if the fast-forwarding operation is performed using the above-described touch screen.

This process is executed from the start of the general reproduction of the sound data (S31).

During the general reproduction, whether or not a touch operation of the user for the bar 83 is performed (S32) is monitored. If the touch operation is detected, waiting is performed for a predetermined time (S33). This predetermined time is a threshold for determining whether or not the touch is the long press and may be set to, for example, about 0.5 seconds. This predetermined time may be adjusted by the user. If the touch does not continue after waiting for the predetermined time, it is determined that the user's operation is a so-called tap operation, and the current position of the sound data which is being generally reproduced is changed to the time point of the touch position (S35). Therefore, the reproduction position of the general reproduction is changed. Thereafter, the process returns to step S32.

If the touch continues after waiting for the predetermined time, it is determined that the user's operation is the long press touch (that is, a fast-forwarding operation) so as to transition to the fast-forwarding operation. That is, in parallel to the general reproduction, the fast-forwarding reproduction is additionally started from the position of the sound data for the touch position (S36). In addition, the sound separation process is started with respect to the general reproduction and the fast-forwarding reproduction (S37). Thereafter, the process progresses to step S38.

If the general reproduction of the sound data is finished (S35), the present process is finished (S45). When the long press touch is finished (S39), the sound separation process is stopped (S40) and additionally the fast-forwarding reproduction is finished (S41). The case where the fast-forwarding reproduction is finished earlier than the general reproduction to the same as the case where the long press touch is finished.

Depending on whether or not the end of the long press touch of step S39 is a first end operation, the process branches into step S43 or S44. If it is not the first end operation, it is determined that it is a second end operation. One of the first and second end operations is the operation for simply finishing the above-described fast-forwarding operation and the other is a specific operation such as the flick operation.

In step S44, the original general reproduction independently continues. In step S43, the general reproduction is resumed from the current position (or a predetermined position) of the fast-forwarding reproduction.

Although the touch position of the bar is assumed the position after (future position) the current reproduction position on the bar during the general reproduction in the above description, the same process as described above may be performed even when a previous (past) position is instructed.

Next, the fast-forwarding operation of a second embodiment of the present disclosure will be described.

The configuration of the sound processing system 10 shown in FIG. 1 is applicable to the second embodiment without change. The configuration of the user input unit 18 of the second embodiment may be any one of the above-described configuration examples. In the first embodiment, the input sound data part was to be fast-forwarding reproduced one data part at a given time. In contrast, in the second embodiment, the input sound data part is to be fast-forwarding reproduced a plurality of input sound data parts at a given time.

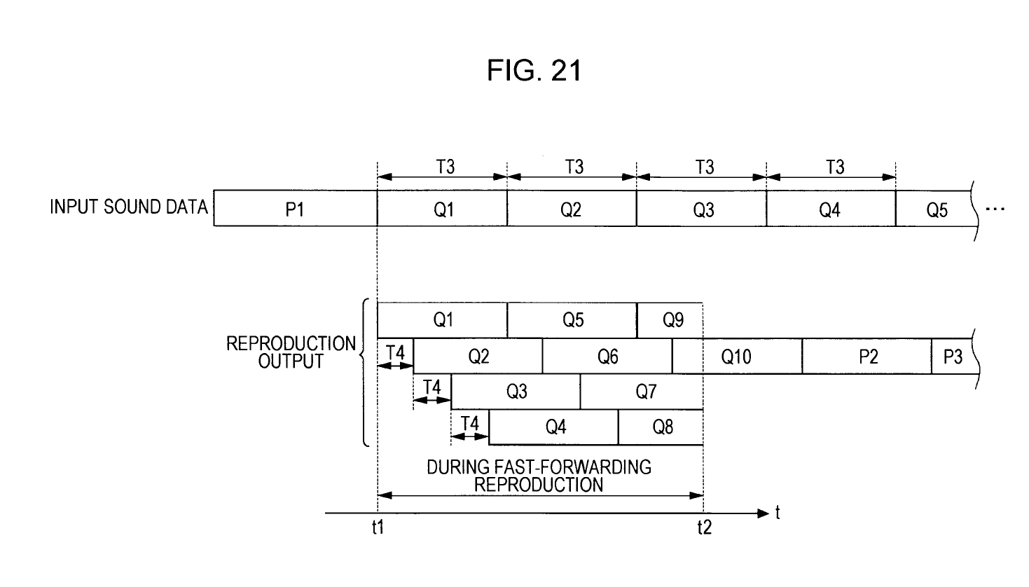

FIG. 21 is a diagram showing a relationship between input sound data and a reproduction output in the second embodiment.

During the general reproduction of the input sound data, at the time point t1 when the fast-forwarding operation of the user is instructed, the fast-forwarding reproduction of the same input sound data is started. That is, a plurality of sound data parts at the position beyond the current reproduction position is divided into a plurality of sections in which a constant length (period T3) is consecutively arranged and the sections are sequentially read so as to perform the reproduction and output in a multiple manner and in a cyclic manner with a predetermined time difference T4. At this time, the sound data parts reproduced in the multiple manner are processed by the sound processing unit so as to be separated and heard and the mixed output sound data is output. At a time point when the fast-forwarding operation is finished, the multiple reproduction finishes and the general reproduction of the input sound data part is resumed from a last sound data part (in the example of FIG. 21, Q10) which is currently being reproduced. As described below, the resuming of the general reproduction is not necessarily limited to the last data part.

According to the fast-forwarding operation of the second embodiment, compared with the fast-forwarding operation of the related art shown in FIG. 9, it is possible to emphasize the plurality of data parts while being identified at a higher speed, without omitting the plurality of parts of the input sound data after the fast-forwarding reproduction start time point. In the example of FIG. 21, it is possible to perform the fast-forwarding reproduction at a speed nearly four times the general reproduction.

In the second embodiment, during the fast-forwarding reproduction, whether or not the general reproduction is continuously executed is not regarded as important. In the example of FIG. 21, the case where the continuous execution of the general reproduction is not performed during the fast-forwarding reproduction is shown.

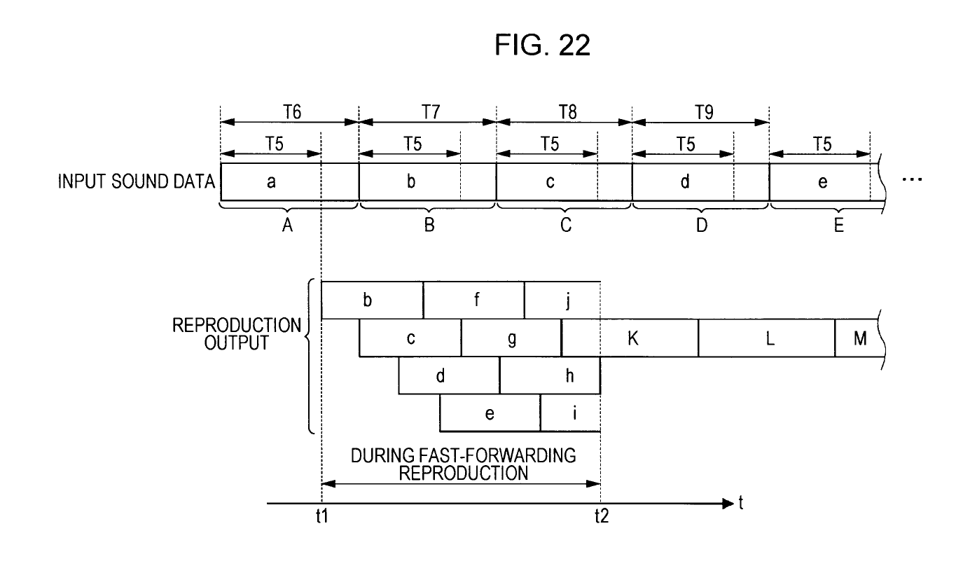

FIG. 22 is a diagram showing a modified example of the second embodiment. In the example shown in FIG. 21, at the same time as the fast-forwarding reproduction, the plurality of sound data parts at the position beyond the current reproduction position of the input sound data was divided into the plurality of sections in which a constant length (period T3) is consecutively arranged and the sections were sequentially read. In contrast, in this modified example, the case where the plurality of sections does not have the constant length described in the example of FIG. 18 is assumed. In this case, among the plurality of sections A, B, C, D, having respective durations T6 to T9, data parts b to k, . . . of the constant duration T5 are sequentially extracted and reproduced from the respective sections B, C, D . . . after the position where the fast-forwarding is instructed. In the reference letters indicating the sections in the figure, a capital letter denotes an overall variable-length section and a small letter denotes a leading part of a constant-length section. The other operations are equal to the above operations.

Next, the separation listening suitable for the multiple reproduction of three or more sound data parts of the second embodiment will be described.

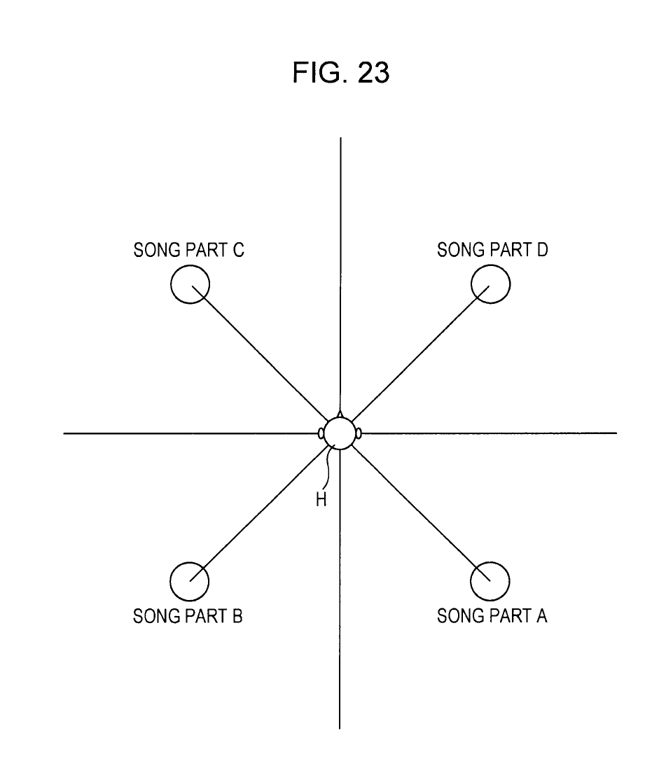

FIG. 23 is a diagram showing a modified example of a method of changing localization described in FIG. 6. This example shows an example of a virtual sound source position of each song part when four song parts are simultaneously reproduced in the multiple manner. The four song parts are arranged on the horizontal plane centered on the head portion H (sound processing device) of the user at an interval of 90° in different directions. Each direction is not particularly limited to the example shown. For example, four directions such as front, back, left and right may be used.

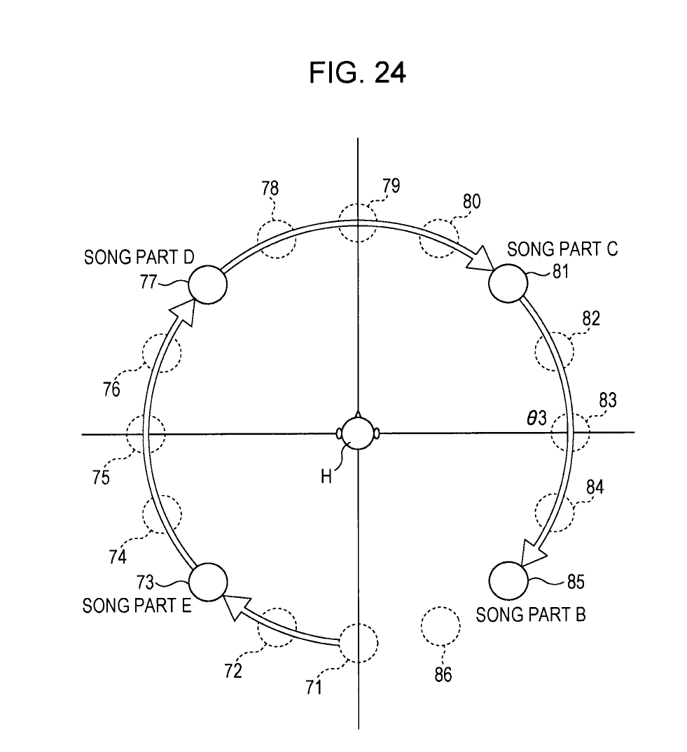

FIG. 24 is a diagram showing an example of changing an audible direction with time from the start to the end of the reproduction of each song part when four song parts are reproduced in a multiple manner, in the modified example shown in FIG. 23. In this example, the audible direction of each song part rotates by almost 360° from the start to the end of the reproduction of the song part. Although, in the example of the figure, the angle interval between the positions 71 to 86 is 22.5°, the angle interval is not limited to 22.5°.

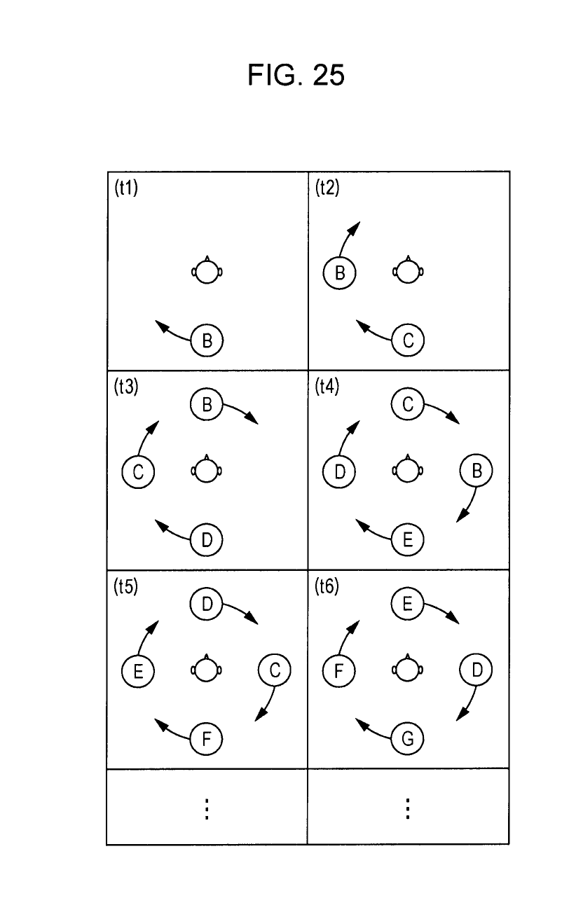

FIG. 25 is a diagram showing a plurality of steps of changing the audible direction of the song part with time, in the examples shown in FIGS. 24 and 22. In this figure, the change of the direction from a time point t11 of the start of the multiple reproduction of the four song parts to a time point t16 with a constant time interval is shown. Each song part rotates from the back position of the user around the head portion of the user in a clockwise direction, the reproduction of the song part continues until reaching the back side again, and the reproduction of the song part is finished. The period (in this example, four seconds) of one 360° rotation corresponds to a time when one song part is reproduced. The respective song parts are sequentially reproduced with a predetermined time difference, that is, ¼ (in this example, 1 second) of one period. Accordingly, a maximum of four song parts is reproduced at a given time in the multiple manner.

When the fast-forwarding operation is finished, the general reproduction is resumed. In the configuration shown in FIG. 24, there are several methods of determining from which song part the general reproduction is resumed. In a first method, among the song parts which are currently being reproduced in the multiple manner, a specific song part (for example, the newest song part) is continuously reproduced. In a second method, among the song parts which are currently being reproduced in the multiple manner, a song part in which a sound source is in a specific direction, that is, a song part audible in a predetermined direction, is continuously reproduced.

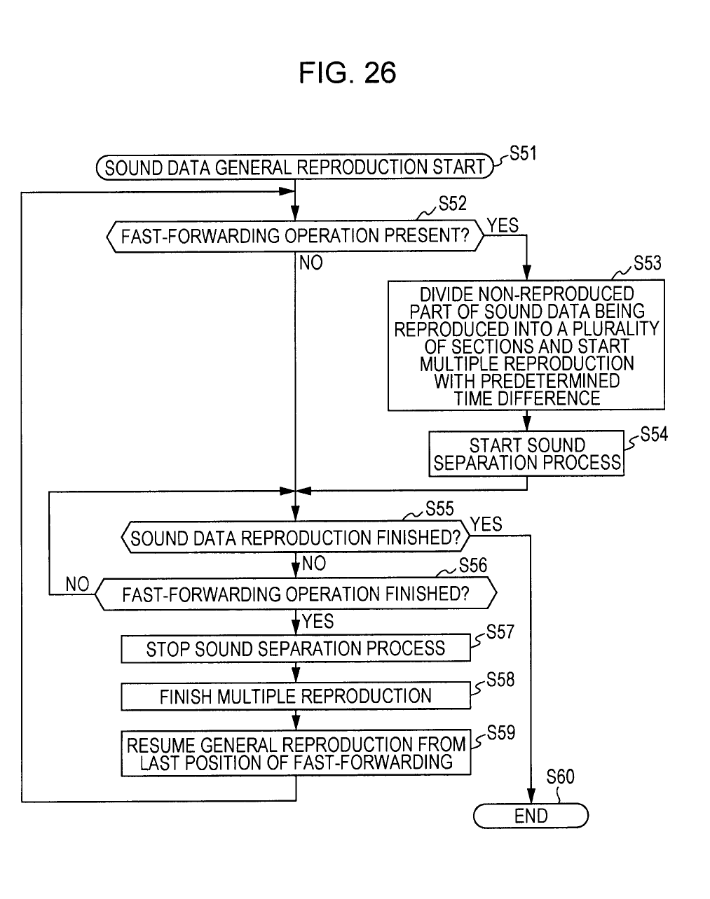

FIG. 26 is a flowchart illustrating an example of processing a fast-forwarding operation of the second embodiment.

This process is executed from the start of the general reproduction of the sound data (S51).

During the general reproduction, whether or not the fast-forwarding operation is performed (S52) is monitored by the user. If the fast-forwarding operation is detected, the fast-forwarding reproduction operation of the present embodiment is started (S53). That is, the non-reproduced part of the sound data which is being reproduced is divided into a plurality of sections and such sections are reproduced in the multiple manner and the cyclic manner with a predetermined time difference. In addition, the sound separation process is started (S54). Thereafter, the process progresses to step S55.

If the general reproduction of the sound data is finished (S55), the present process finishes (S60). When the fast-forwarding operation finishes (S56), the sound separation process is paused (S57) and the multiple reproduction finishes (S58). Next, the general reproduction is resumed from the last position (or a predetermined position) of the fast-forwarding (S59). Thereafter, the process returns to step S52.

In addition, although the example in which the parallel reproduction of the general reproduction during the multiple reproduction is not performed is shown in this process, the parallel reproduction of the general reproduction may be performed similar to the first embodiment. In this case, the virtual sound source position of the general reproduction is preferably the position of the head portion H.

Although the suitable embodiments of the present disclosure are described, various modification and changes may be made in addition to the above description. That is, it is apparent to those skilled in the art that the above embodiments are exemplary and various modified examples of a combination of components and processes may be made and such modified examples are in the scope of the present disclosure.

For example, although only the fast-forwarding reproduction is described, the present disclosure is also applicable to rewinding reproduction in the same manner. In the rewinding reproduction, the reproduction order of the above-described blocks or sections may be reversed.

Although the position of the virtual sound source is in the horizontal plane in the present embodiment, it may be set in a three-dimensional space centered on the head portion H.

A computer program for realizing the functions described in the above embodiments on a computer and a computer-readable storage medium for storing the program are included in the present disclosure. Examples of the “storage medium” for supplying the program include a magnetic storage medium (a flexible disk, a hard disk, a magnetic tape, or the like), an optical disc (a magneto-optical disc, a CD, a DVD, or the like), or a semiconductor storage.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a storage unit configured to store audio data;
an input unit configured to receive an input instruction of a user;
a reproduction unit configured to reproduce a plurality of channels of the audio data;
a sound processing unit configured to process the plurality of channels of the audio data output by the reproduction unit;
a control unit configured to control the reproduction unit to reproduce a first channel of the audio data, which corresponds to normal playback of the audio data, and reproduce a second channel of the audio data, which corresponds to a fast-forwarding playback of the audio data based on an instruction received at the input unit, and to control the sound processing unit to process the first and second channels of the audio data to be separately audible by the user; and
an output unit configured to output the first and second channels of the audio data output from the sound processing unit.

2. The information processing apparatus of claim 1, wherein the input unit includes a display configured to display a status bar indicating a reproduction status of the audio data.

3. The information processing apparatus of claim 2, wherein the display of the input unit is configured to receive a touch input on the status bar, and the controller is configured to control the reproduction unit to perform the fast-forwarding playback based on the touch input received at the display.

4. The information processing apparatus of claim 1, wherein the control unit is configured to control the reproduction unit to reproduce only the first channel of audio data from a point corresponding to an end point of the fast-forwarding playback of the second channel of the audio data upon completion of the fast-forwarding playback.

5. The information processing apparatus of claim 1, wherein the output unit comprises a digital-to-analog converter configured to convert the first and second channels of the audio data into an analog signal.

6. The information processing apparatus of claim 5, wherein the output unit comprises an amplifier configured to amplify the analog signal.

7. The information processing apparatus of claim 1, wherein the sound processing unit comprises a preprocessing unit configured to control gain of the first and second channels of the audio data to be uniform.

8. The information processing apparatus of claim 1, wherein the sound processing unit comprises a frequency band division filter configured to perform a frequency band division process on the first and second channels of the audio data.

9. The information processing apparatus of claim 8, wherein the frequency band division filter is configured to divide an audible frequency band into a plurality of frequency bands and exclusively assign each one of the plurality of frequency bands to one of the first or second channels of the audio data.

10. The information processing apparatus of claim 1, wherein the sound processing unit comprises a time division filter configured to perform a time division process on the first and second channels of the audio data.

11. The information processing apparatus of claim 10, wherein the time division filter is configured to modulate an amplitude of each of the first and second channels of the audio data such that time points at which the amplitude modulated first channel of audio data are maximized overlap with time points at which the amplitude modulated second channel of audio data are minimized.

12. The information processing apparatus of claim 1, wherein the sound processing unit comprises a processing filter configured to apply a predetermined processing effect to at least one of the first and second channels of the audio data.

13. The information processing apparatus of claim 1, wherein the sound processing unit further comprises a localization filter configured to process the first and second channels of the audio data to differentiate a perceived direction of a sound source corresponding each of the first and second channels of the audio data.

14. An information processing performed by an information processing apparatus, the method comprising:
storing audio data at a storage unit of the information processing apparatus;
receiving an input instruction of a user at an input unit of the information processing apparatus;
reproducing a first channel of the audio data, which corresponds to normal playback of the audio data, and a second channel of the audio data, which corresponds to a fast-forwarding playback of the audio data based on an instruction received at the input unit;
processing the first and second channels of the audio data such that the first and second channels of the audio data are separately audible by the user; and
outputting the processed first and second channels of the audio data.

15. The method of claim 14, further comprising:
reproducing only the first channel of audio data from a point corresponding to an end point of the fast-forwarding playback of the second channel of the audio data upon completion of the fast-forwarding playback.

16. The method of claim 14, wherein the processing includes performing a frequency band division process on the first and second channels of the audio data.

17. The method of claim 14, wherein the processing includes performing a time division process on the first and second channels of the audio data.

18. The method of claim 14, wherein the processing includes applying a predetermined processing effect to at least one of the first and second channels of the audio data.

19. The method of claim 14, wherein the processing includes processing the first and second channels of the audio data to differentiate a perceived direction of a sound source corresponding each of the first and second channels of the audio data.

20. An information processing apparatus comprising:
means for storing audio data;
means for receiving an input instruction of a user;
means for reproducing a plurality of channels of the audio data;
means for processing the plurality of channels of the audio data output by the means for reproducing such that the plurality of channels of the audio data are separately audible by the user;
means for controlling the means for reproducing to reproduce a first channel of the audio data, which corresponds to normal playback of the audio data, and reproduce a second channel of the audio data, which corresponds to a fast-forwarding playback of the audio data based on an instruction received at the means for receiving, and for controlling the sound processing unit to process the first and second channels of the audio data to be separately audible by the user; and
means for outputting the first and second channels of the audio data output from the means for processing.
